(19) United States
(12) Patent Application Publication
(10) Pub. No.: US 2018/0012243 A1
(43) Pub. Date: Jan. 11, 2018

(54) EXPENDITURE DATA SYSTEM

(71) Applicant: TAIWAN NAME PLATE CO., LTD., NEW TAIPEI CITY (TW)

(72) Inventors: WEN-CHENG YIN, NEW TAIPEI CITY (TW); CHI-HUNG CHANG, NEW TAIPEI CITY (TW); KAI-LI PENG, NEW TAIPEI CITY (TW)

(21) Appl. No.: 15/369,082

(22) Filed: Dec. 5, 2016

(30) Foreign Application Priority Data
Jul. 6, 2016 (TW) 105210190

(51) Int. Cl. G06Q 30/02; G06Q 20/32

(52) U.S. Cl. CPC G06Q 30/0207; G06Q 20/322

(57) ABSTRACT

An expenditure data system including a bonus server, a data server, a mobile communication device and a wearable device is provided. The bonus server may store the bonus point information. The data server generates special offering information according to the consumption report. The mobile communication device receives the bonus point information and the consumption report, and transmits the bonus point information and the consumption report to the bonus server and the data server, respectively. The mobile communication device also downloads the special offering information. The wearable device generates the consumption report in response to purchasing operation involving the wearable device, and generates the bonus point information according to the consumption report. The wearable device transmits the consumption report and the bonus point information to the mobile communication device, and analyzes the consumption report to generate and display an expenditure analysis.

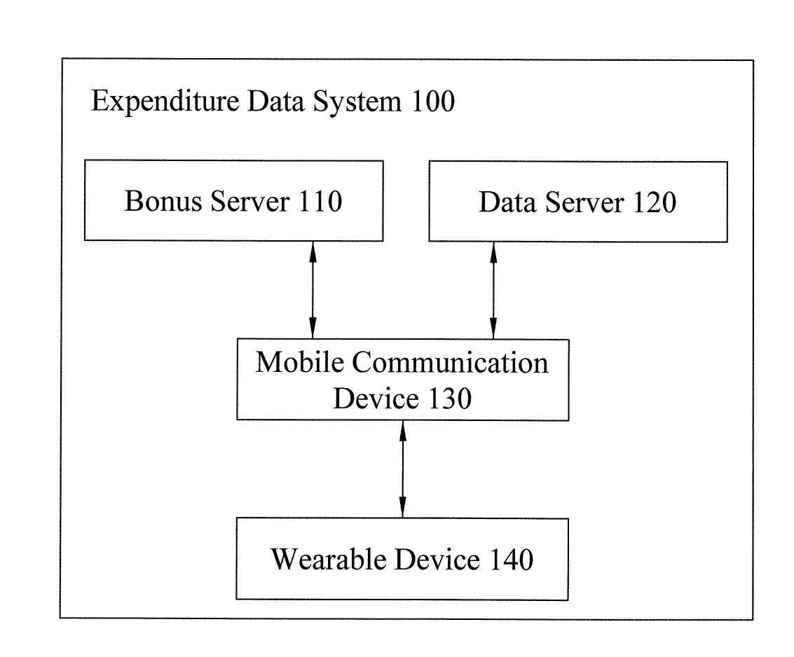

### CROSS-REFERENCE TO RELATED APPLICATION

This application claims priority from Taiwan Patent Application No. 105210190, filed on Jul. 6, 2016, in the Taiwan Intellectual Property Office, the content of which is hereby incorporated by reference in its entirety for all purposes.

### BACKGROUND OF THE INVENTION

### 1. Field of the Invention

The present invention is related to a data system. More specifically, the present invention is related to an expenditure data system capable of generating bonus point in response to purchasing operation, providing special offering information, and performing expenditure analysis.

### 2. Description of the Related Art

Normally, the smartwatch comes with all kinds of functions, such as the calculation, playback, display, detection, etc.

However, the aforementioned functions only make the smartwatch a composite device with functions of a calculator, media player, display device or a detector, and it still lacks the integration with cloud and the application relevant to big data. Hence, the extent of the application of the functions thereof is limited.

### SUMMARY OF THE INVENTION

The purpose of the present invention is to provide an expenditure data system, which aims to solve the aforementioned problems in the art.

To that aim, the present invention provides an expenditure data system, which may include a bonus server, a data server, a mobile communication device, and a wearable device. The bonus server may store the bonus point information. The data server may generate special offering information according to at least one piece of expenditure info. The mobile communication device may receive at least one consumption report and bonus point information, and may respectively transmit the bonus point information and the at least one consumption report to the bonus server and the data server for storage. The mobile communication device may also download the special offering information. The wearable device may generate the consumption report in response to a purchasing operation involving the wearable device, and may generate the bonus point information according to the consumption report. The wearable device may transmit the consumption report and the bonus point information to the mobile communication device, and may analyze the consumption report to generate and display an expenditure analysis.

Preferably, the data server may store data defining a plurality of offers. The data server may generate the special offering information according to at least one of the offers that corresponds to the consumption report.

Preferably, each consumption report may correspond to at least one spending category.

Preferably, the wearable device may generate expenditure analysis according to at least one spending category.

In conclusion, using the wearable device, the expenditure data system of the present invention may generate bonus point information according to the consumption report, and stores the bonus point information at the bonus server. The expenditure data system of the present invention may also return the consumption report corresponding to the purchasing operation to the data server, such that the data server may generate the corresponding special offering information. The wearable device may analyze the consumption report to obtain the expenditure analysis, and henceforth the user may be more willing to spend money using the wearable device.

### BRIEF DESCRIPTION OF THE DRAWINGS

The sole FIGURE is the first block diagram of the expenditure data system of the present invention.

### DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

For better understanding of the description hereinafter, reference should be made to the FIGURE, which is the first block diagram of the expenditure data system of the present invention. As shown in the drawings, the expenditure data system 100 of the present invention may include a bonus server 110, a data server 120, a mobile communication device 130, and a wearable device 140. In a preferred embodiment, the mobile communication device 130 may be a smartphone, a tablet or any other electronic devices with information receiving and transmitting capabilities. The mobile communication device 130 may include one or more processors and a memory. The processor thereof may be configured to execute the program stored in the memory of the mobile communication device 130. The memory thereof may also store the computation results of the processor. In a preferred embodiment, wearable device 140 may be a smartwatch or any other wearable electronic devices with capability to receive, transmit and display information. The wearable device 140 may include at least one processor and a memory. The memory of the wearable device 140 may store the programs executable by the processor, and the memory may also store the computation results of the processor. In addition, the bonus server 110 and the data server 120 may be computers systems with a memory storing computer codes and at least one CPU (central processing unit), and the bonus server 110 and the data server 120 may be connected to the mobile communication device 130 via wireless network, and the mobile communication device 130 may be connected to the wearable device 140 via wired or wireless communication.

The aforementioned bonus server 110 may be used to store the bonus point information. In one embodiment, the bonus point information may be the bonus point or loyalty point, which is rewarded by a retailer or service provider to the customer for frequenting the retailer or service provider, and the bonus point or loyalty point may be used to redeem free gifts or discounts. The data server 120 may generate special offering information according to at least one consumption report. The mobile communication device 130 may receive the bonus point information and at least one consumption report, and may transmit the bonus point information and the consumption report respectively to the bonus server 110 and the data server 120 for storage. The mobile communication device 130 may also download the special offering information from the data server 120. The wearable device 140 may generate at least one consumption report in response to a purchasing operation involving the wearable device 140, and may generate the bonus point information according to the consumption report. The wearable device 140 may transmit the consumption report and the bonus point information to the mobile communication device 130, and may subsequently analyze the consumption report to generate and display an expenditure analysis. The purchasing operation may be transaction between the user and a retailer providing products or services to the user. In one embodiment, the purchasing operation may performed by receiving and processing the request from the user to purchase product or service from the terminal of retailer, and the action is achieved via the method of NFC (near field communication) or contactless payment. The wearable device 140 may be configured to provide a user interface for the user to perform the purchasing operation. For example, the wearable device 140 may render the price, quantity or the list of the product or service on a touchscreen thereof. The user may select the desired product or service, and send out a purchasing request to the terminal of retailer via NFC. Upon receiving the purchasing request, the retailer terminal may be configured to process the request and send out a confirmation via NFC to the wearable device 140 acknowledging the reception of the request. The purchasing operation may be performed via a combination of hardware, software or firmware, but the present embodiment is not limited thereto. In response to the purchasing operation, the processor of the wearable device 140 may process the data involving the purchasing operation using the program or algorithms stored in the memory thereof, and then generate the consumption report including records associated with the purchasing operations.

For instance, when the wearable device 140 has the contactless payment capability, following the payment, the wearable device 140 of the expenditure data system 100 may generate the corresponding consumption report and bonus point information. The consumption report and the bonus point information may first be transmitted by the wearable device 140 to the mobile communication device 130, and then the mobile communication device 130 may transmit the bonus point information to the bonus server 110 for storage. In addition, the mobile communication device 130 may transmit the consumption report to the data server 120. The bonus server 110 may store the bonus point information after receiving the bonus point information. After receiving the consumption report, the data server 120 may generate the special offering information accordingly, and the special offering information can be downloaded by the mobile communication device 130. More specifically, the wearable device 140 may determine how many bonus points that purchasing operation has earned according to the category, product, shop, or amount regarding the spending. The consumption report may correspond to a spending category, which indicates the type of item or the user has spent his money on. In the case of public transport, the item may belong to the spending category of transportation. Therefore, the wearable device 140 may then perform statistical analysis according to the spending category of at least one consumption report and produce the expenditure analysis, which may provide the user with relevant expenditure analysis such as the proportion or sum of the expenses in each category or on each item.

In addition, the bonus point information may be used to redeem items (e.g. products, services, or discounts), but the invention is not limited thereto.

On the other hand, the data server 120 may generate the corresponding special offering information after collecting certain amount of consumption reports. More specifically, the data server 120 may perform statistics or analyze the spending activities corresponding to a plurality of consumption reports, so as to generate the corresponding special offering information or the special offering information that suits most of the users.

Furthermore, the data server 120 may store data defining a plurality of offers, and the offers may be downloaded by the data server 120 on its own, or may be imported to the data server 120 from external sources. The data server 120 may generate the special offering information according to at least one of the offers that corresponds to at least one consumption report. That is to say, among those offers, the data server 120 may find at least one offer that fits the consumption trend or demand of at least one consumption report, and may generate the special offering information for user's reference. Since the special offering information is related to the consumption report, the user might have higher willingness to take advantage of the special offering information and spend his money.

In conclusion, using the wearable device, the expenditure data system of the present invention may generate bonus point information according to the consumption report, and stores the bonus point information at the bonus server. The expenditure data system of the present invention may also return the consumption report corresponding to the spending activity to the data server, such that the data server may generate the corresponding special offering information. The wearable device may analyze the consumption report to obtain the expenditure analysis, and henceforth the user may be more willing to spend money using the wearable device.

In accordance with the embodiment(s) of the present invention, the components, process steps, and/or data structures described herein may be implemented using various types of operating systems, computing platforms, computer programs, and/or machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a nontransitory medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An expenditure data system, comprising:
a bonus server storing bonus point information;
a data server generating special offering information according to at least one consumption report;
a mobile communication device receiving the bonus point information and the at least one consumption report, the mobile communication device further transmitting the bonus point information and the consumption report respectively to the bonus server and the data server for storage, and downloading the special offering information; and
a wearable device generating the at least one consumption report in response to a purchasing operation involving the wearable device, and generating the bonus point information according to the consumption report, the wearable device further transmitting the consumption report and the bonus point information to the mobile communication device, and analyzing the at least one consumption report to generate and display an expenditure analysis.

2. The expenditure data system of claim 1, wherein the data server stores data defining a plurality of offers, and the data server generates the special offering information according to at least one of the offers that correspond to the at least one consumption report.

3. The expenditure data system of claim 1, wherein each of the consumption report corresponds to at least one spending category.

4. The expenditure data system of claim 3, wherein the wearable device generates the expenditure analysis according to the at least one spending category.
